(19) United States
(12) Patent Application Publication
(10) Pub. No.: US 2014/0068113 A1
(43) Pub. Date: Mar. 6, 2014

(54) DATA TRANSMISSION BETWEEN A PORTABLE ELECTRONIC DEVICE AND VARIOUS ACCESSORY DEVICES VIA RESPECTIVE DEDICATED CONNECTION INTERFACES

(71) Applicant: Sheng-Long YANG, Taipei City (TW)

(72) Inventor: Sheng-Long YANG, Taipei City (TW)

(21) Appl. No.: 13/790,045

(22) Filed: Mar. 8, 2013

(30) Foreign Application Priority Data
Sep. 5, 2012 (TW) 101132294

(51) Int. Cl. G06F 13/40

(52) U.S. Cl. CPC G06F 13/4068
USPC 710/16

(57) ABSTRACT

A portable electronic device comprises: a detecting unit for generating a detecting signal based on detection of a signal level at a detection terminal of a multi-interface extension connector, which includes plural connection interfaces dedicated for data transmission and is matable with an accessory connector of an accessory device; and a processing unit operable to control the extension connector to allow data transmission with the accessory device via at least one connection interface that is determined to be compatible with the accessory device based on accessory information from the accessory device upon detecting, based on the detecting signal, that the extension connector is coupled with the accessory connector.

### CROSS-REFERENCE TO RELATED APPLICATION

This application claims priority to Taiwanese Application No. 101132294, filed on Sep. 5, 2012, the contents of which are hereby incorporated by reference.

### BACKGROUND OF THE INVENTION

1. Field of the Invention

The invention relates to data transmission, and more particularly to data transmission between a portable electronic device and various accessory devices via respective dedicated connection interfaces.

2. Description of the Related Art

A conventional portable electronic device, for example, a mobile phone, a personal digital assistant, etc., usually provides a single extension interface, such as a universal serial bus (USB) interface, for an accessory device.

### SUMMARY OF THE INVENTION

An object of the present invention is to provide a portable electronic device that is capable of data transmission with various accessory devices via respective dedicated connection interfaces.

According to the present invention, there is provided a portable electronic device capable of use with a plurality of different accessory devices. Each of the accessory devices includes an accessory connector. The portable electronic device of the present invention comprises a multi-interface extension connector, a detecting unit, and a processing unit. The multi-interface extension connector is matable with the accessory connector of each of the accessory devices. The multi-interface extension connector includes a detection terminal, and a plurality of connection interfaces dedicated for data transmission. Each of the connection interfaces is compatible with at least a corresponding one of the accessory devices. The detecting unit is connected electrically to the multi-interface extension connector for detecting a signal level present at the detection terminal of the multi-interface extension connector to output a detecting signal corresponding to the signal level detected thereby. The processing unit is connected electrically to the detecting unit and the multi-interface extension connector, and receives the detecting signal from the detecting unit. The processing unit is operable to determine, based on the detecting signal, whether the multi-interface extension connector is coupled with the accessory connector of one of the accessory devices.

The processing unit is operable to
communicate with said one of the accessory devices to receive accessory information therefrom upon detecting that the multi-interface extension connector is coupled with the accessory connector of said one of the accessory devices,
determine, based on the accessory information from said one of the accessory devices, from among the connection interfaces of the multi-interface extension connector, at least one connection interface that is compatible with said one of the accessory devices, and
control the multi-interface extension connector to allow data transmission between the processing unit and said one of the accessory devices via the at least one connection interface from among the connection interfaces of the multi-interface extension connector.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic block diagram illustrating a preferred embodiment of a portable electronic device capable of use with various accessory devices according to the present invention;

FIG. 2 is a schematic view showing an exemplary configuration of a socket base of a multi-interface extension connector of the portable electronic device;

FIG. 3 is a schematic block diagram illustrating the preferred embodiment when coupled with an image capturing device;

FIG. 4 is a schematic block diagram illustrating the preferred embodiment when coupled with an audio input/output device;

FIG. 5 is a schematic block diagram illustrating the preferred embodiment when coupled with a video output device; and

FIG. 6 is a schematic block diagram illustrating the preferred embodiment when coupled with a multimedia player.

### DETAILED DESCRIPTION OF THE PREFERRED EMBODIMENT

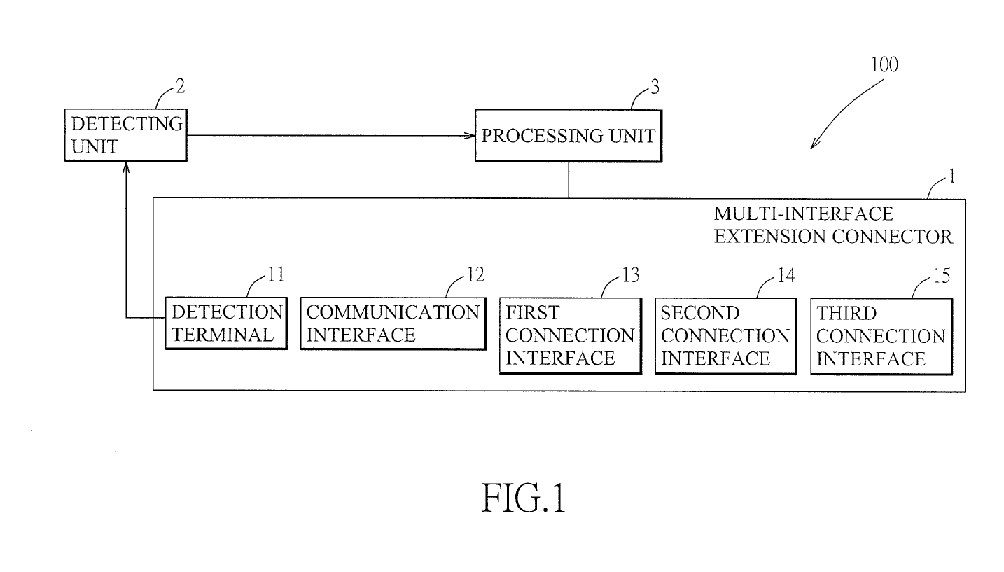

Referring to FIG. 1, the preferred embodiment of a portable electronic device 100 capable of use with various accessory devices (not shown) according to the present invention is shown to include a multi-interface extension connector 1, a detecting unit 2, a processing unit 3. The portable electronic device 100 can be a mobile phone or a PDA. The accessory devices include, but are not limited to an image capturing device (e.g., a digital camera), an audio input/output device (e.g., a speaker device and a microphone device) , a video output device (e.g., a display device), and a multimedia device (e.g., a multimedia player and a digital video camera).

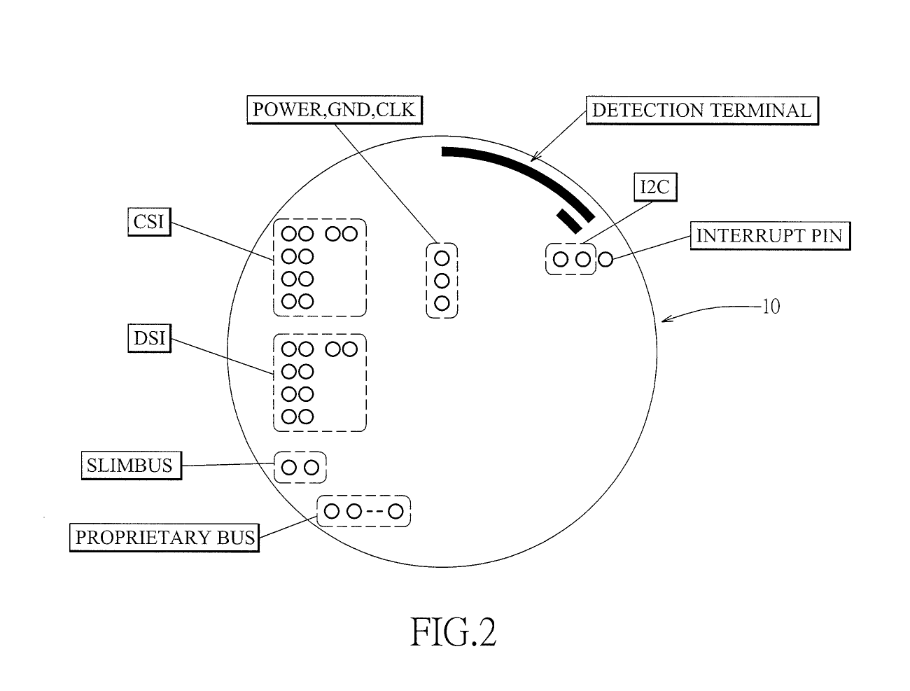

The multi-interface extension connector 1 is matable with an accessory connector (not shown) of each of the accessory devices. The multi-interface extension connector 1 includes a detection terminal 11, a communication interface 12, a first connection interface 13, a second connection interface 14, and a third connection interface 15. Each of the first, second and third connection interfaces 13, 14, 15 is compatible with at least a corresponding one of the accessory devices. In this embodiment, the communication interface 12 is, for example, but not limited to an inter-integrated circuit (I2C) interface. The first connection interface 13 is, for example, but not limited to a camera serial interface (CSI) dedicated for image data transmission. The second connection interface 14 is, for example, but not limited to a serial low-power inter-chip media bus (SLIMbus) dedicated for audio data transmission. Alternatively, the second connection interface 14 can be an integrated inter-chip sound (I2S) interface. The third connection interface 15 is, for example, but not limited to a display serial interface (DSI) dedicated for video data transmission. For example, as shown in FIG. 2, the multi-interface extension connector 1 includes a socket base 10 that is configured with two detection pads serving as the detection terminal 11, the I2C interface, the CSI interface, the SLIMbus, and the DSI. The socket base 10 is further configured with power, GND, CLK terminals, and a proprietary bus. It is noted that, in this embodiment, the detection terminal 11 is capable of being supplied with one of a first voltage and a second voltage. The first voltage is normally supplied to the detection terminal 11. However, in the event that a connector plug (not shown) of one of the accessory devices that are adapted for use with the portable electronic device 100 is correctly inserted into the socket base 10 of the multi-interface extension connector 1 (i.e., the multi-interface extension connector 1 is coupled with the accessory connector of said one of the accessory devices), the second voltage is supplied to the detection terminal 11 in response to a coupling between the multi-interface extension connector 1 and the accessory connector of said one of the accessory devices. The first voltage is lower than the second voltage, but is not limited thereto. For example, the first voltage is 0V, and the second voltage is 2.4V.

The detecting unit 2 is connected electrically to the multi-interface extension connector 1 for detecting a signal level present at the detection terminal 11 of the multi-interface extension connector 1 to output a detecting signal corresponding to the signal level detected thereby. In this embodiment, the signal level is a voltage level. The detecting signal indicates that the signal level present at the detection terminal 11 of the multi-interface extension connector 1 changes from a current level, i.e., the first voltage, to a predetermined level, i.e., the second voltage, in response to the coupling between the multi-interface extension connector 1 and the accessory connector of said one of the accessory devices.

The processing unit 3 is connected electrically to the detecting unit 2 and the multi-interface extension connector 1. The processing unit 3 receives the detecting signal from the detecting unit 2. The processing unit 3 is operable to determine, based on the detecting signal, whether the multi-interface extension connector 1 is coupled with the accessory connector of one of the accessory devices.

Upon detecting that the multi-interface extension connector 1 is coupled with the accessory connector of said one of the accessory devices, the processing unit 3 is operable to communicate with said one of the accessory devices via the communication interface 12 of the multi-interface extension connector 1 using I2C communication protocol to receive accessory information from said one of the accessory devices. Then, the processing unit 3 is operable to determine, based on the accessory information from said one of the accessory devices, from among the first, second and third connection interfaces 13, 14, 15 of the multi-interface extension connector 1, at least one connection interface that is compatible with said one of the accessory devices . Thereafter, the processing unit 3 is operable to control the multi-interface extension connector 1 to allow data transmission between the processing unit 3 and said one of the accessory devices via the at least one connection interface from among the first, second and third connection interfaces 13, 14, 15 thus determined to be compatible with said one of the accessory devices.

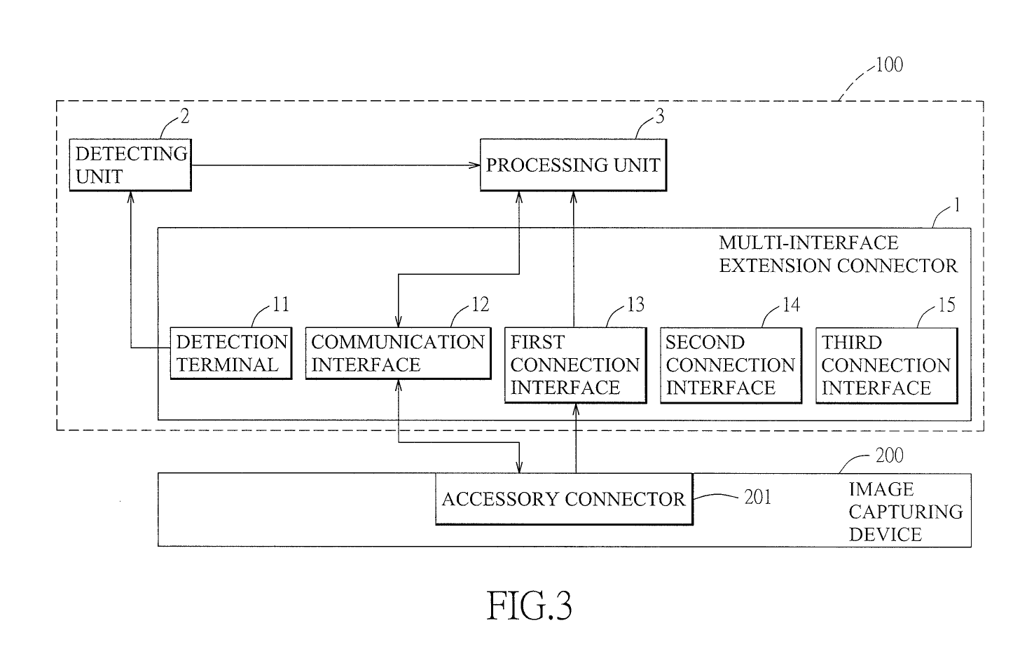

FIG. 3 illustrates an example of the portable electronic device 100 when coupled with an image capturing device 200 for capturing an image to generate image data. In this example, after coupling between the multi-interface extension connector 1 and an accessory connector 201 of the image capturing device 200, the processing unit 3 determines that the first connection interface 13 is compatible with the image capturing device 200 based on accessory information received from the image capturing device 200 through the communication interface 12. The multi-interface extension connector 1 is then controlled by the processing unit 3 so that the first connection interface 13 is dedicated to transmit the image data from the image capturing device 200 to the processing unit 3.

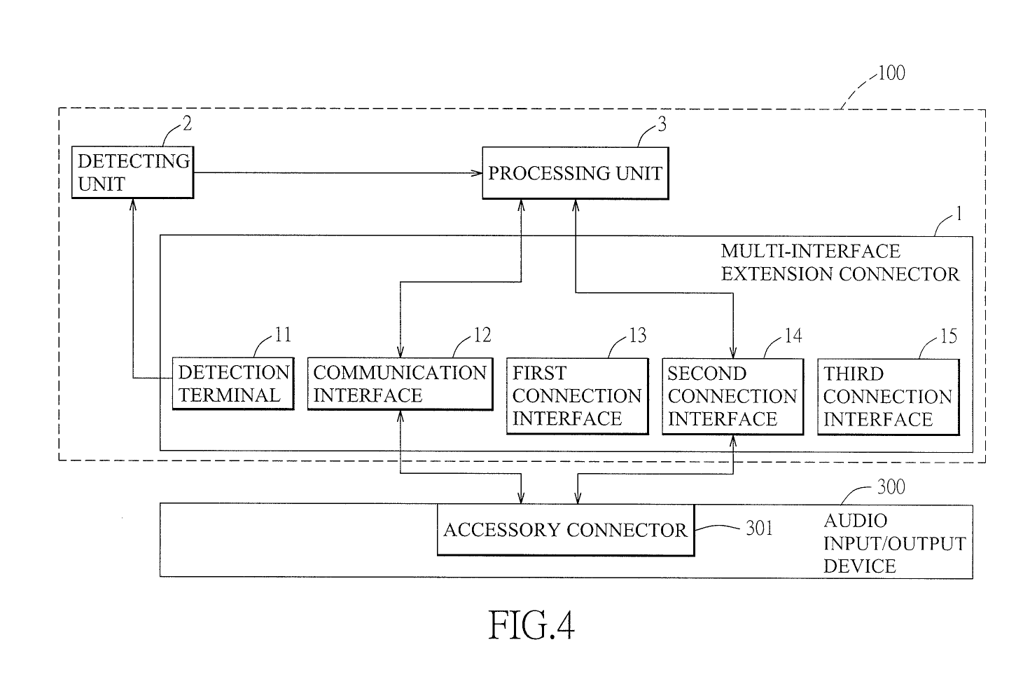

FIG. 4 illustrates another example of the portable electronic device 100 when coupled with an audio input/output device 300. In this example, after coupling between the multi-interface extension connector 1 and an accessory connector 301 of the audio input/output device 300, the processing unit 3 determines that the second connection interface 14 is compatible with the audio input/output device 300 based on accessory information received from the audio input/output device 300 through the communication interface 12. The multi-interface extension connector 1 is then controlled by the processing unit 3 so that the second connection interface 14 is dedicated for audio data transmission between the processing unit 3 and the audio input/output device 300.

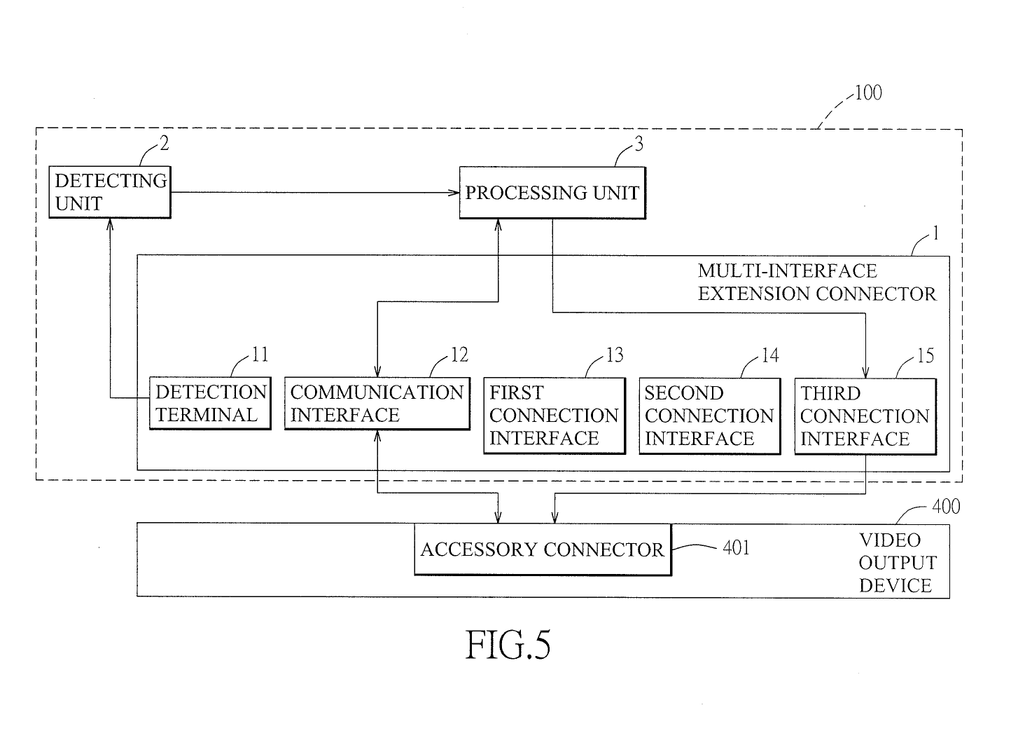

FIG. 5 illustrates a further example of the portable electronic device 100 when coupled with a video output device 400. In this example, after coupling between the multi-interface extension connector 1 and an accessory connector 401 of the video output device 400, the processing unit 3 determines that the third connection interface 15 is compatible with the video output device 400 based on accessory information received from the video output device 400 through the communication interface 12. The multi-interface extension connector 1 is then controlled by the processing unit 3 so that the third connection interface 15 is dedicated to transmit video data from the processing unit 3 to the video output device 400.

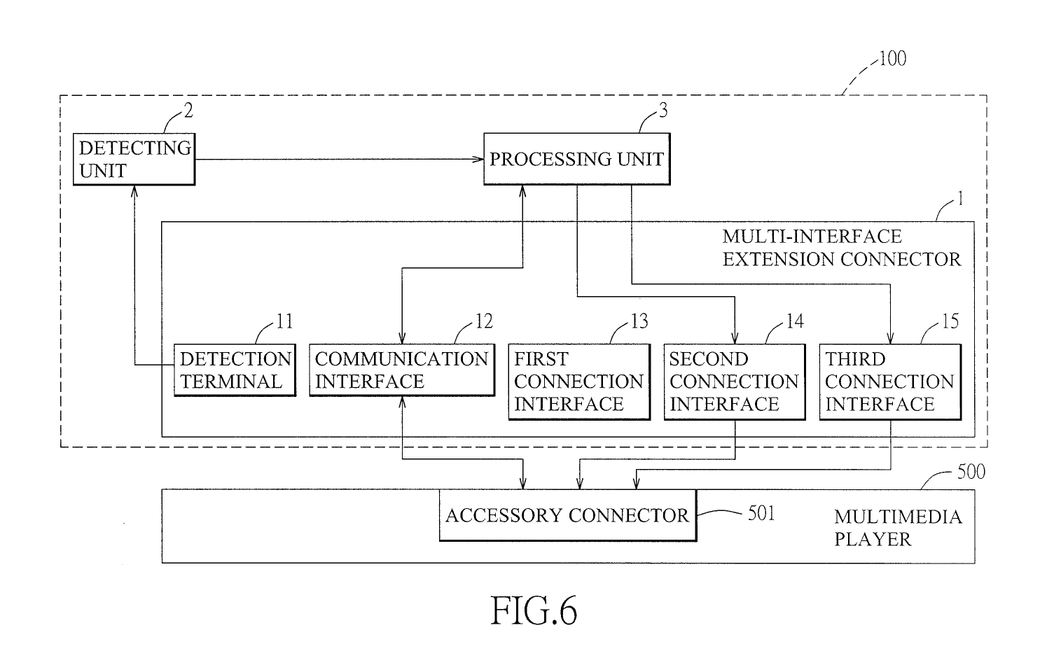

FIG. 6 is a still further example of the portable electronic device 100 when coupled with a multimedia player 500. In this example, after coupling between the multi-interface extension connector 1 and an accessory connector 501 of the multimedia player 500, the processing unit 3 determines that the second and third connection interfaces 14, 15 are both compatible with the multimedia player 500 based on accessory information received from the multimedia player 500 through the communication interface 12. The multi-interface extension connector 1 is then controlled by the processing unit 3 so that the second and third connection interfaces 14, 15 are respectively dedicated to transmit audio data and video data from the processing unit 3 to the multimedia player 500.

To sum up, due to the presence of the multi-interface extension connector 1, the portable electronic device 100 of the present invention can achieve high-speed data transmission between the processing unit 3 and compatible accessory devices via the respective dedicated connection interfaces 13, 14, 15.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A portable electronic device capable of use with a plurality of different accessory devices, each of the accessory devices including an accessory connector, said portable electronic device comprising:
a multi-interface extension connector matable with the accessory connector of each of the accessory devices, said multi-interface extension connector including a detection terminal, and a plurality of connection interfaces that are dedicated for data transmission, each of said connection interfaces being compatible with at least a corresponding one of the accessory devices;
a detecting unit connected electrically to said multi-interface extension connector for detecting a signal level present at said detection terminal of said multi-interface extension connector to output a detecting signal corresponding to the signal level detected thereby; and
a processing unit connected electrically to said detecting unit and said multi-interface extension connector, and receiving the detecting signal from said detecting unit, said processing unit being operable to determine, based on the detecting signal, whether said multi-interface extension connector is coupled with the accessory connector of one of the accessory devices;
wherein said processing unit is operable to
communicate with said one of the accessory devices to receive accessory information therefrom upon detecting that said multi-interface extension connector is coupled with the accessory connector of said one of the accessory devices,
determine, based on the accessory information received from said one of the accessory devices, from among said connection interfaces of said multi-interface extension connector, at least one connection interface that is compatible with said one of the accessory devices, and
control said multi-interface extension connector to allow data transmission between said processing unit and said one of the accessory devices via the at least one connection interface from among said connection interfaces of said multi-interface extension connector.

2. The portable electronic device as claimed in claim 1, wherein the detecting signal outputted by said detecting unit indicates that the signal level present at said detection terminal of said multi-interface extension connector changes from a current level to a predetermined level in response to coupling between said multi-interface extension connector and the accessory connector of said one of the accessory devices.

3. The portable electronic device as claimed in claim 2, wherein the signal level is a voltage level, and the current level is lower than the predetermined level.

4. The portable electronic device as claimed in claim 1, said one of the accessory devices is an image capturing device for capturing an image to generate image data, wherein said one of said connection interfaces of said multi-interface extension connector determined by said processing unit to be compatible with the image capturing device is dedicated to transmit the image data from the image capturing device to said processing unit.

5. The mobile computer device as claimed in claim 4, wherein said one of said connection interfaces of said multi-interface extension connector determined by said processing unit is a camera serial interface (CSI).

6. The portable electronic device as claimed in claim 1, said one of the accessory devices is an audio input/output device, wherein said one of said connection interfaces of said multi-interface extension connector determined by said processing unit to be compatible with the audio input/output device is dedicated for audio data transmission between said processing unit and the audio input/output device.

7. The portable electronic device as claimed in claim 6, wherein said one of said connection interfaces of said multi-interface extension connector determined by said processing unit is one of a serial low-power inter-chip media bus (SLIMbus) and an integrated inter-chip sound (I2S) interface.

8. The portable electronic device as claimed in claim 1, said one of the accessory devices is a video output device, wherein said one of said connection interfaces of said multi-interface extension connector determined by said processing unit to be compatible with the video output device is dedicated to transmit video data from said processing unit to the video output device.

9. The portable electronic device as claimed in claim 8, wherein said one of said connection interfaces of said multi-interface extension connector determined by said processing unit is a display serial interface (DSI).
